(19) United States
(12) Patent Application Publication
(10) Pub. No.: US 2012/0038942 A1
(43) Pub. Date: Feb. 16, 2012

(54) IMAGE FORMING APPARATUS AND IMAGE FORMING METHOD

(75) Inventor: Toshiyuki UMETSU, Shizuoka (JP)

(73) Assignees: Toshiba Tec Kabushiki Kaisha, Tokyo (JP); Kabushiki Kaisha Toshiba, Tokyo (JP)

(21) Appl. No.: 13/205,400

(22) Filed: Aug. 8, 2011

Related U.S. Application Data
(60) Provisional application No. 61/372,423, filed on Aug. 10, 2010.

(51) Int. Cl. G06F 3/12

(52) U.S. Cl. 358/1.13

(57) ABSTRACT

Certain embodiments provide an image forming apparatus including a determination part, a display part, an image processing part, an image forming part, an inversion conveyance part, a finishing part and a main control part. The determination part determines whether image data is digital book data. If the image data is the digital book data, the display part displays a digital book print mode. The image processing part arithmetically processes the digital book data. The image forming part forms an image on a sheet. The inversion conveyance part inverts the sheet on one side of which the image is formed and conveys the sheet to the image forming part. The finishing part finishes the sheet to which the image is formed. The main control part automatically controls at least one of the image processing part, the inversion conveyance part and the finishing part specified based on the digital book print mode.

### CROSS-REFERENCE TO RELATED APPLICATION

This application is based upon and claims the benefit of priority from Provisional U.S. Applications 61/372,423 filed on Aug. 10, 2010, the entire contents of which are incorporated herein by reference.

### FIELD

Embodiments described herein relate generally to an image forming apparatus and an image forming method.

### BACKGROUND

A multi function peripheral (hereinafter referred to as an MFP) of related art can print an image on a sheet based on digital book data as one of image data.

In an image forming apparatus including the MFP of the related art, in order to form a book from the digital book data, an optimizing process (for example, magazine sort, 2-in-1 process) to optimize the digital book data, two-sided printing, saddle stitch and the like are required to be set as a print mode.

However, the user is required to operate a control panel and to perform the various settings one by one. Accordingly, to form a book from digital book data by using the image forming apparatus of the related art is very troublesome for the user.

### BRIEF DESCRIPTION OF THE DRAWINGS

FIG. 1 is a schematic structural view showing an image forming apparatus of a first embodiment.

FIG. 2 is a block diagram showing an electrical structure of the image forming apparatus of the first embodiment.

FIG. 3 is a flowchart showing an image forming method of the first embodiment.

FIG. 4 is a view showing a setting screen of a digital book print mode displayed on a control panel device.

FIG. 5 is an explanatory view for explaining magazine sort.

FIG. 6 is an explanatory view for explaining a 2-in-1 process.

FIG. 7 is an explanatory view for explaining a saddle stitch.

FIG. 8 is a flowchart showing an image forming method of a second embodiment.

FIG. 9 is a view showing a selection screen of digital book print modes displayed on a control panel device.

### DETAILED DESCRIPTION

In general, according to one embodiment, an image forming apparatus includes a determination part, a display part, an image processing part, an image forming part, an inversion conveyance part, a finishing part and a main control part. The determination part determines whether image data is digital book data. If the determination part determines that the image data is the digital book data, the display part automatically displays a digital book print mode for forming a book from the digital book data. The image processing part arithmetically processes the digital book data. The image forming part forms an image based on the digital book data on a sheet. The inversion conveyance part inverts the sheet on one side of which the image is formed by the image forming part and conveys the sheet to the image forming part. The finishing part finishes the sheet on which the image is formed by the image forming part. The main control part includes the determination part and the image processing part, and automatically controls at least one of the image processing part, the inversion conveyance part and the finishing part specified based on the digital book print mode displayed on the display part.

According to another embodiment, an image forming method includes determining whether image data is digital book data, displaying a digital book print mode, controlling at least one of an image processing part, an inversion conveyance part and a finishing part, and forming a book. The digital book print mode is a digital book print mode for forming a book from the digital book data, and is automatically displayed if the determination is that the image data is the digital book data. At least one of the image processing part, the inversion conveyance part and the finishing part is automatically controlled based on the displayed digital book print mode. Here, the image processing part arithmetically processes the digital book data. The inversion conveyance part inverts a sheet on one side of which an image is formed by an image forming part to form the image based on the digital book data on a sheet, and conveys the sheet to the image forming part. The finishing part finishes the sheet on which the image is formed by the image forming part. The book is formed by an image forming apparatus including the image processing part, the inversion conveyance part and the finishing part which are controlled based on the digital book print mode, and the image forming part.

According to another embodiment, an image forming method includes determining whether image data is digital book data, displaying a digital book print mode, controlling an image processing part, an inversion conveyance part and a finishing part, and forming a book. The digital book print mode is a digital book print mode for forming a book from the digital book data, and is automatically displayed if the determination is that the image data is the digital book data. The image processing part, the inversion conveyance part and the finishing part are automatically controlled based on the displayed digital book print mode. Here, the image processing part performs an optimum arithmetic processing for forming the book on the digital book data. The inversion conveyance part inverts a sheet on one side of which an image is formed by an image forming part to form the image based on the digital book data on a sheet, and conveys the sheet to the image forming part. The finishing part includes a saddle stitch part that staples a center part of the sheets on which the image is formed by the image forming part and folds the sheets in two along the center part of the sheet. The book is formed by an image forming apparatus including the image processing part, the inversion conveyance part and the finishing part which are controlled based on the digital book print mode, and the image forming part.

Hereinafter, an image forming apparatus and an image forming method of embodiments will be described.

### First Embodiment

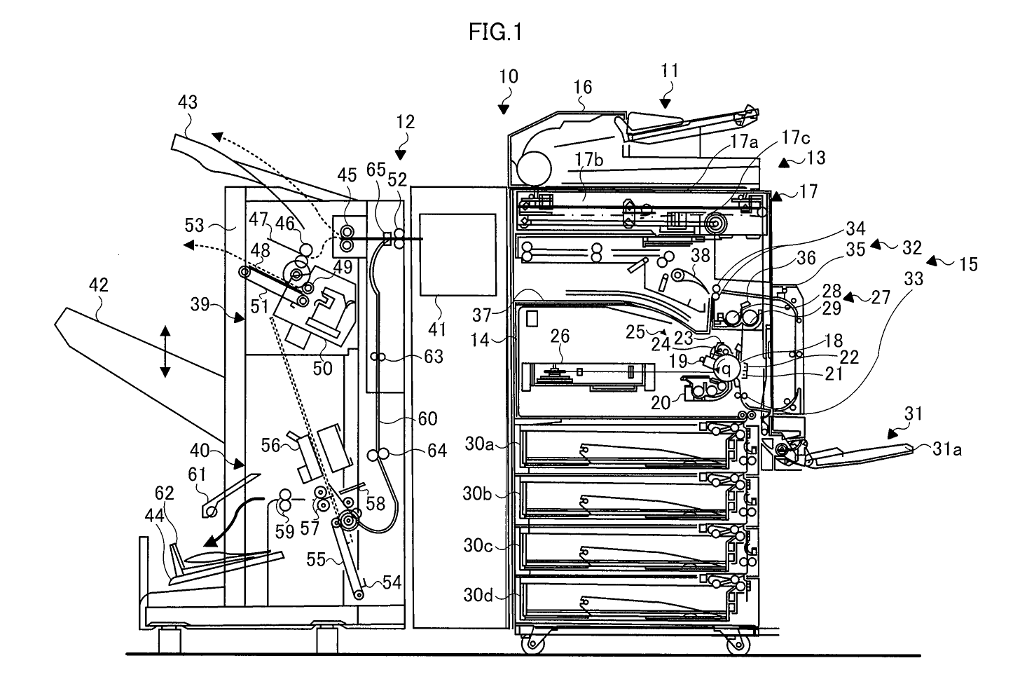

FIG. 1 is a schematic structural view showing an image forming apparatus of a first embodiment. An image forming apparatus 10 shown in FIG. 1 includes an MFP (Multi Function Peripheral or Multi Function Printer) 11 and a finisher 12 as a finishing part.

The MFP 11 includes a scanner part 13, an image forming part 14 and a sheet conveyance part 15. The scanner part 13 reads a document image, and forms image data based on the read image.

The scanner part 13 includes an auto document feeder 16 (hereinafter referred to as an ADF 16) and a scanner device 17.

The ADF 16 feeds a document to the scanner device 17. The scanner device 17 reads the document image and forms the image data based on the read image.

The scanner device 17 includes a document glass 17a on which the document fed from the ADF 16 is placed, an optical unit 17b to irradiate the document with light and condenses reflected light from the document, and a CCD scanner unit 17c to read the light from the optical unit 17b. The scanner device 17 reads the document image by these components.

The image forming part 14 includes a printer device 25 including a photoconductive drum 18, a charging device 19, a developing device 20, a transfer charger 21, a peeling charger 22, a cleaner 23 and a charge removing LED 24. Besides, the image forming part 14 includes a laser device 26. The charging device 19, the developing device 20, the transfer charger 21, the peeling charger 22, the cleaner 23 and the charge removing LED 24 constituting the printer device 25 are provided around the photoconductive drum 18 in this order in an arrow q rotation direction of the photoconductive drum 18.

The charging device 19 uniformly charges a surface of the photoconductive drum 18. The laser device 26 irradiates laser light to the photoconductive drum 18, the surface of which is charged, based on the image data formed by the scanner part 13 or digital book data captured into the image forming apparatus 10 through an after-mentioned external connection part, and forms an electrostatic latent image. The developing device 20 supplies toner to the surface of the photoconductive drum 18 on which the electrostatic latent image is formed, and forms a toner image based on the electrostatic latent image. The transfer charger 21 transfers the toner image formed on the surface of the photoconductive drum 18 onto a sheet. By this, the image forming part 14 forms the toner image on the sheet. Incidentally, the peeling charger 22 performs AC corona discharge, and peels the sheet, which adhered to the photoconductive drum 18 at the time of transfer, from the photoconductive drum 18. The cleaner 23 removes toner remaining on the surface of the photoconductive drum 18 after the toner image is transferred. The charge removing LED 24 removes the electric charge of the surface of the charged photoconductive drum 18.

The image forming part 25 includes a fixing device 27. The fixing device 27 includes a heat roller 28 and a press roller 29. In the fixing device 27, the heat roller 28 and the press roller 29 nip and convey a sheet, heat and press the toner image formed on the sheet, and fix the toner image on the sheet.

The image forming part 14 forms the toner image on the sheet, fixes the toner image and prints the image based on the image data or the digital book data on the sheet.

The sheet conveyance part 15 conveys a sheet supplied from cassette mechanisms 30a to 30d containing sheets of different sizes or a sheet supplied from a manual feed mechanism 31 including a paper feed tray 31a to a specified portion. The sheet conveyance part 15 includes an inversion conveyance part 32 and an aligning roller 33.

The inversion conveyance part 32 includes an upper and lower paper discharge roller pair 34, and an inversion part 35. The upper and lower paper discharge roller pair 34 negatively rotate, and convey the sheet on one side of which an image is printed to the inversion part 35. The inversion part 35 inverts the sheet conveyed by the upper and lower paper discharge roller pair 34, and again conveys the sheet to the image forming part 14. That is, the inversion conveyance part 32 inverts the sheet so that an image is formed on the other side of the sheet on one side of which an image is formed, and conveys the sheet to the image forming part 14.

The aligning roller 33 aligns a leading edge of the sheet supplied from one of the cassette mechanisms 30a to 30d, the manual paper feed mechanism 31 and the inversion conveyance part 32, and conveys the sheet to the photoconductive drum 18 in synchronization with the toner image.

Besides, the MFP 11 includes a paper sensor 36 and a sheet discharge unit. The paper sensor 36 is provided downstream of the fixing device 27, and detects the leading edge of the sheet. The sheet discharge unit is the upper and lower paper discharge roller pair 34 included in the inversion conveyance part 32, and these positively rotate, so that the sheet on one side or both sides of which the image is formed is discharged to a paper discharge part 37 of the MFP 11 or the finisher 12 attached to the MFP 11.

Incidentally, the MFP 11 includes a gate mechanism 38. The gate mechanism 38 is a mechanism to discharge a sheet in a direction toward either of the paper discharge part 37 and the finisher 12. The upper and lower paper discharge roller pair 34 as the sheet discharge unit discharge the sheet on which the image is printed in the direction determined by the gate mechanism 38.

The finisher 12 is disposed adjacently to the MFP 11. The finisher 12 is a paper discharge mechanism of an option of the MFP 11, and finishes the sheet on which an image is printed by the image forming part 14 and which is discharged from the MFP 11. For example, the finisher 12 shown in FIG. 1 includes, as a finishing mechanism, a staple part 39 to staple a sheet bundle, a saddle stitch part 40 to fold a sheet in two and to staple a specified position of a fold line, and a cutter part 41 to form a cut line for forming a heading tag in the sheet.

The finisher 12 includes a paper discharge tray 42 to which the sheet stapled or sorted by the staple part 39 is discharged, and a fixed tray 43, and includes a paper discharge tray 44 to which a sheet bundle folded in two by the saddle stitch part 40 is discharged.

The staple part 39 includes an inlet roller 45, a paper feed roller 46, a stand-by tray 47, a processing tray 48, a vertical alignment roller 49, a stapler 50 and a conveyance belt 51.

The inlet roller 45 receives the sheet discharged by the upper and lower paper discharge roller pair 34 as the sheet discharge unit of the MFP 11 through the cutter part 41 and a conveyance roller 52 of the finisher. The inlet roller 45 sends the received sheet in one of dotted line arrow directions shown in the drawing. For example, when the inlet roller 45 sends the received sheet to the paper feed roller 46, the paper feed roller 46 sends the sheet received from the inlet roller 45 to the stand-by tray 47.

The stand-by tray 47 stacks sheets and has an openable structure. When a specified number of sheets are stacked, the stand-by tray 47 is opened, and the sheets drop to the processing tray 48 by their own weight or an operation of a drop assistant member. The processing tray 48 is disposed below the stand-by tray 47, and stacks the sheets dropped from the stand-by tray 47.

The sheets stacked on the processing tray 48 are guided to the stapler 50 by the vertical alignment roller 49 and are stapled. The processing tray 48 aligns and stacks the sheets while the stapler 50 staples the sheets.

The conveyance belt 51 conveys the stapled sheets to the paper discharge tray 42. The sheets conveyed by the conveyance belt 51 are discharged to the paper discharge tray 42 through a discharge port 53. The paper discharge tray 42 moves up and down as indicated by an arrow in the drawing, and receives the sheets.

The finisher 12 can discharge the sheets to the paper discharge tray 42 without stapling. In this case, the sheets on the stand-by tray 47 are not dropped to the processing tray 48, but are discharged to the paper discharge tray 42 through the discharge port 53. Besides, the finisher 12 includes an aligning device to align the conveyed sheets in the width direction, and can sort and discharge the sheets by using the aligning device. Further, in the finisher 12, when no finishing in addition to stapling is performed, the sheet conveyed from the MFP 11 is discharged to the paper discharge tray 42 or the fixed tray 43 as it is.

The saddle stitch part 40 includes a stack tray 54, a guide belt 55, a stapler 56, a folding roller pair 57, a blade 58 and a discharge roller pair 59.

The stack tray 54 receives sheets conveyed from the MFP 11 through a paper path 60 in the finisher 12. The sequentially conveyed sheets are stacked on the stack tray 54 and become a sheet bundle.

The guide belt 55 conveys the sheet bundle formed on the stack tray 54 to the stapler 56. When a center part of the sheet bundle reaches the stapler 56, the guide belt 55 once stops, and the stapler 56 staples the center part of the sheet bundle. Besides, the guide belt 55 lowers the stapled sheet bundle so that the center part of the sheet bundle stops at a position of a nip point of the folding roller pair 57.

When the sheet bundle is lowered to this position, the blade 58 arranged at a position opposite to the folding roller pair 57 projects the center part of the sheet bundle to the nip point of the folding roller pair 57, and pushes the sheet bundle into a space between the folding roller pair 57. The folding roller pair 57 rotate while folding and nipping the sheet bundle, and fold the sheet bundle in two. The sheet bundle folded in two is conveyed by the discharge roller pair 59 as indicated by an arrow in the drawing, and is discharged to the paper discharge tray 44.

A press mechanism 61 to press the sheet or the sheet bundle folded in two and a stopper 62 to receive the discharged sheet or sheet bundle are provided in the vicinity of the paper discharge tray 44.

Incidentally, the finisher 12 includes guide rollers 63 64 to guide the sheet discharged from the MFP 11 along the paper path 60. Besides, the finisher 12 includes, at an exit of the conveyance roller 52, a gate 65 to convey the sheet discharged from the MFP 11 to the staple part 39 side or the saddle stitch part 40 side. The gate 52 is switched so that the sheet is conveyed to the staple part 39 side or the saddle stitch part 40 side.

The cutter part 41 is arranged between, for example, the MFP 11 and the staple part 39. Incidentally, the arrangement position of the cutter part 41 is not limited to the illustrated position, and may be any position as long as the position is located upstream of the saddle stitch part 40.

The cutter part 41 forms a U-shaped cut line in the center of the sheet in the conveyance direction. When the cut line is formed by the cutter part 41, and when the sheet is folded in two by the saddle stitch part 40, an area defined by the cut line rises, and a heading tag is formed.

Incidentally, since the cutter part 41 is for forming the heading tag, when formation of the tag is not required, the sheet sent from the MFP 11 passes through the cutter unit 41 without formation of the cut line.

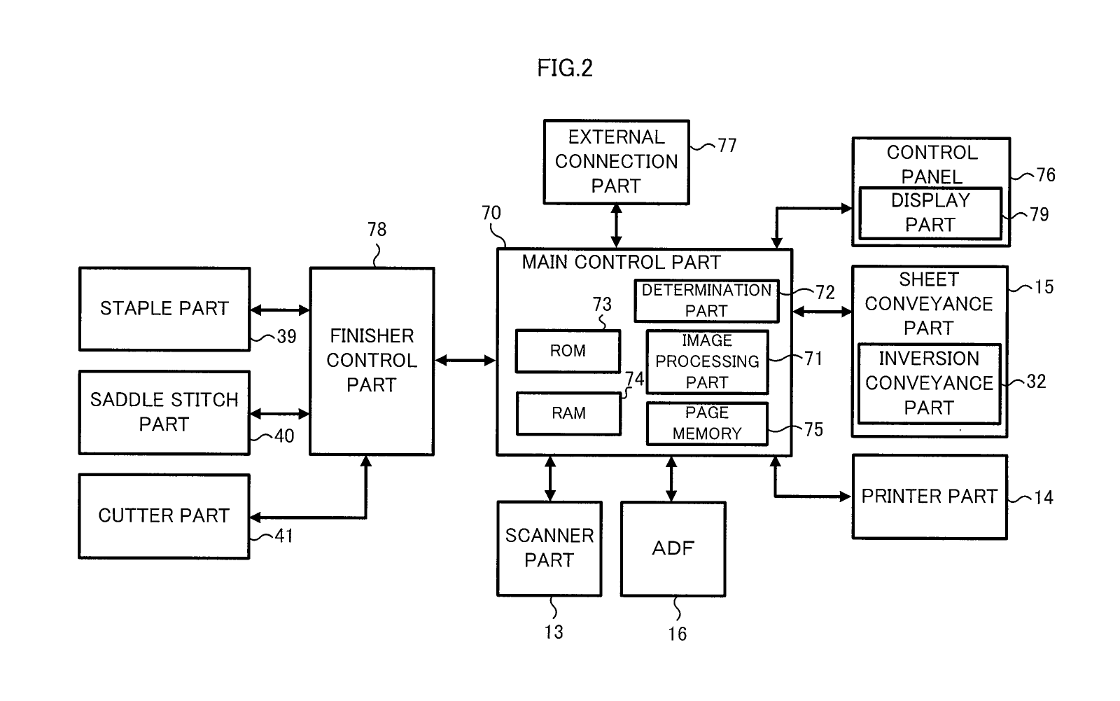

FIG. 2 is a block diagram showing an electric structure of the image forming apparatus 10 of the first embodiment. The image forming apparatus 10 includes a main control part 70 to control the whole apparatus. The main control part 70 includes a CPU, and includes an image processing part 71 to arithmetically process digital book data and image data formed by the scanner part 13, a determination part 72 to determine whether image data is digital book data, and an inner storage device including a ROM 73, a RAM 74 and a page memory 75.

The image data formed by the scanner part 13, the image data or the digital book data received from the outside of the image forming apparatus 10, or the like is once stored in the page memory 75. The image processing part 71 arithmetically processes the image data or the digital book data stored in the page memory 75, and again stores in the page memory 75.

The ROM 73 stores a control program for controlling the image forming apparatus 10. The image forming apparatus 10 is controlled in accordance with the control program.

The RAM 74 stores information relating to a digital book print mode.

The main control part 70 is connected with the scanner part 13, the ADF 16, the image forming part 14, the inversion conveyance part 32, a control panel 76, an external connection part 77 and a finisher control part 78, and controls these.

The control panel 76 includes a display part 79 formed of, for example, a touch panel. A user operates the control panel 76, and can give various instructions for printing to the image forming apparatus 10.

The external connection part 77 enables transmission and reception of various data between the image forming apparatus 10 and the outside of the apparatus 10, and captures the digital book data, the image data or the like into the image forming apparatus 10 from the outside of the apparatus 10. The external connection part 77 connects the image forming apparatus 10 to a network such as, for example, the Internet, and connects the image forming apparatus 10 and the network such as the Internet so as to enable mutual communication. The interface for connection in this case is Bluetooth (registered trademark), wireless LAN or the like. Besides, the external connection part 77 may be a terminal for connecting the external storage device such as a flash memory and the image forming apparatus 10 so as to enable mutual communication.

The finisher control part 78 is connected to the staple part 39, the saddle stitch part 40 and the cutter part 41 of the finisher 12, and controls these. Since the finisher control part 78 is connected to the main control part 70, the MFP 11 and the finisher 12 operate in cooperation with each other.

The control of the saddle stitch part 40 by the finisher control part 78 includes control of the stapler 56, control of the blade 58, and rotation control of the folding roller pair 57 and the discharge roller pair 59.

In the image forming apparatus 10 shown in FIG. 2, if the determination part 72 determines that image data is digital book data, the image process ing part 71 performs an optimum arithmetic processing for forming a book from the digital book data. The optimum arithmetic processing is, for example, magazine sort or 2-in-1 process (process of converting digital book data of two pages into digital book data of one page). A specific example of these processes will be described later.

The display part 79 of the control panel 76 automatically displays a digital book print mode for forming a book from digital book data.

When the digital book print mode is displayed on the display part 79 of the control panel 76, the control part 70 controls at least one of the image processing part 71, the inversion conveyance part 32 and the finisher control part 78 so that various processes specified in the displayed digital book print mode are executed.

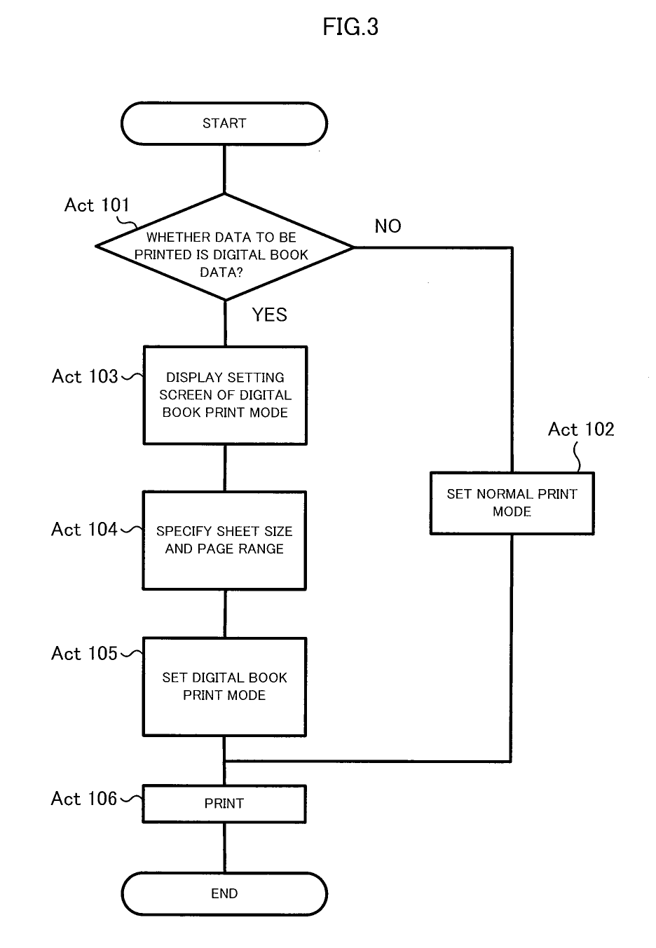

Next, an image forming method of the first embodiment will be described with reference to FIG. 3. FIG. 3 is a flowchart showing the image forming method of the first embodiment.

First, the determination part 72 of the main control part 70 determines whether the image data to be printed is the digital book data (Act 101). This determination is automatically performed when the digital book data is captured into the image forming apparatus 10 through the external connection part 77. Besides, when the digital book data is previously stored in the page memory 75, the determination is performed when the user operates the control panel 76 and selects printing of the digital book data.

When the digital book data is captured into the image forming apparatus 10 through the external connection part 77, the digital book data is stored in the page memory 75.

If the determination is that the image data to be printed is not the digital book data (Act 101, NO), the main control part 70 sets a normal print mode (Act 102). The setting of the normal print mode may be suitably performed by user's operation of the control panel 76.

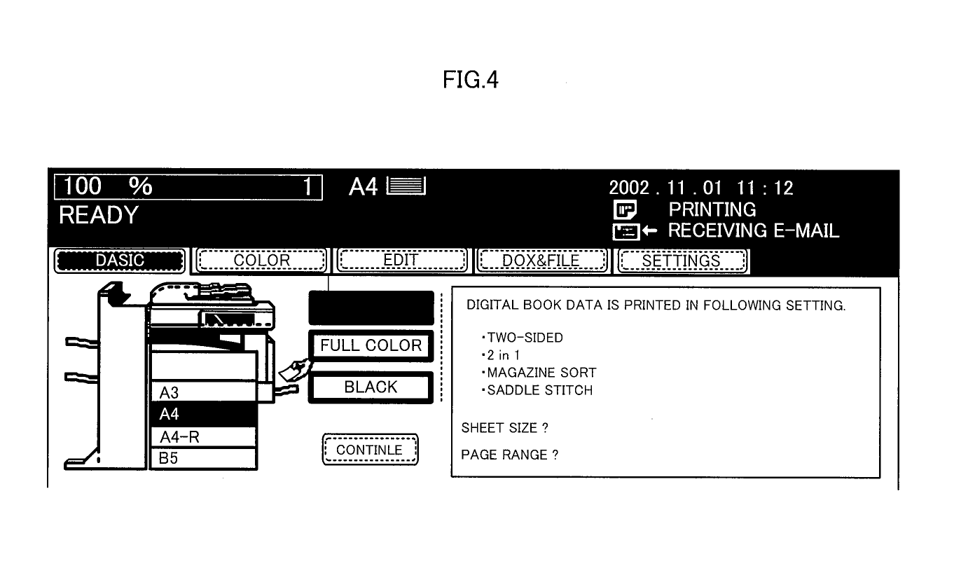

If the determination is that the image data to be printed is the digital book data (Act 101, YES), the main control part 70 reads information relating to the digital book print mode from the RAM 74, and automatically displays a setting screen of the digital book print mode as shown in FIG. 4 on the display part 79 of the control panel 76 (Act 103).

The digital book print mode for printing the digital book data is displayed on the setting screen of the digital book print mode shown in FIG. 4. The digital book print mode includes optimum arithmetic processing to form a book from digital book data, for example, magazine sort and 2-in-1 process, two-sided printing, and saddle stitch.

Incidentally, the digital book print mode is displayed on the setting screen of the digital book print mode shown in FIG. 4, and further, a selection request for a sheet size to be printed and a selection request for a page range of digital book data to be printed are displayed for the user.

The user specifies the sheet size and the page range (Act 104) in response to the selection requests for the sheet size and the page range at Act 103. The user operates the control panel 76 so that this specification is performed.

When the sheet size and the page range are specified, the main control part 70 controls the sheet conveyance part 15 to take out a sheet of the specified sheet size from one of the cassette mechanisms 30a to 30d, and fetches the digital book data within the specified page range from the page memory 75.

Next, the main control part 70 sets the digital book print mode in the image forming apparatus 10 (Act 105) based on the digital book print mode displayed on the display part 79 of the control panel 76 at Act 103. When the digital book print mode shown in FIG. 4 is set, the main control part 70 controls the main processing part 71, the inversion conveyance part 32 and the finisher control part 78.

When the digital book print mode is set, the main control part 70 controls the image processing part 71. The controlled image processing part 71 performs, as the optimum arithmetic processing to form the book from the data, the magazine sort and the 2-in-1 process on the digital book data.

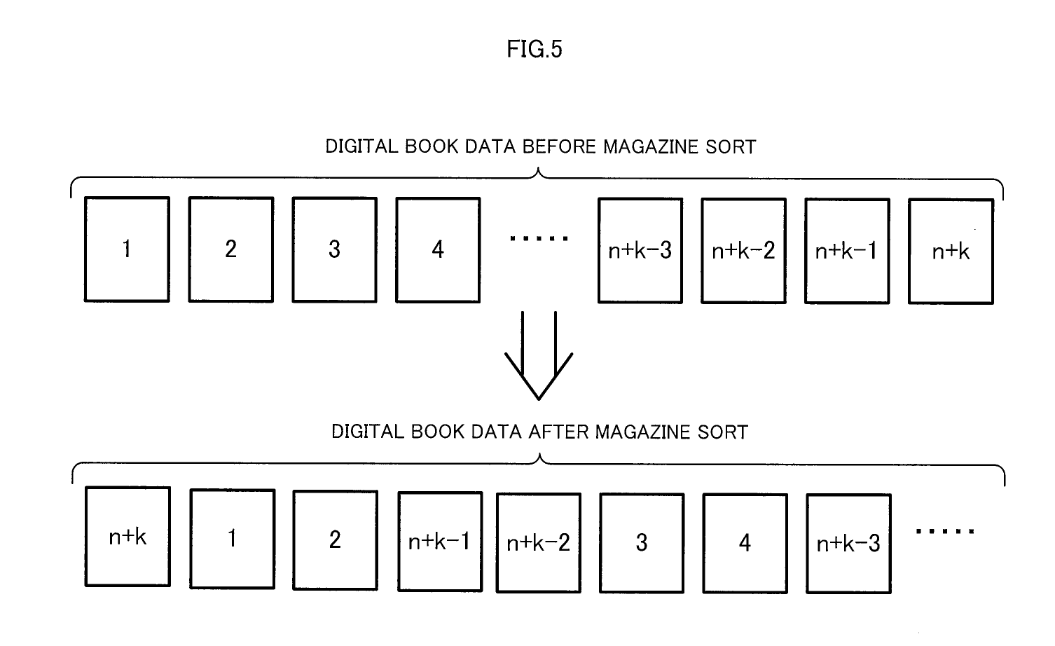

FIG. 5 is a view for explaining the magazine sort. As shown in FIG. 5, when the magazine sort is set as the optimum arithmetic processing, the image processing part 71 rearranges the digital book data having the page number of 1 to n as described below.

First, the image processing part determines whether the page number (n) of the final page (n-th page) is a multiple of 4.

Next, digital book data which becomes blank sheets of k pages (k=0 or 1 or 2 or 3) is added to the final page of the digital book data, so that the total page number of the digital book data and the digital book data which becomes the blank sheets becomes a multiple of 4. When n is the multiple of 4, k is 0, and when n is not the multiple of 4, k is one of 1, 2 and 3.

As described below, the magazine sort is performed on temporal digital book data in which the digital book data which becomes the blank sheets is appropriately added to the digital book data.

As shown in FIG. 5, in the magazine sort, page data arranged in order of 1, 2, 3, 4, . . . , n+k−3, n+k−2, n+k−1, n+k is rearranged in order of n+k, 1, 2, n+k−1, n+k−2, 3, 4, n+k−3 . . . .

The digital book data rearranged in this way is again stored in the page memory 75.

Incidentally, the magazine sort is performed when the 2-in-1 process is set as another optimum arithmetic processing. When a 4-in-1 process (process of converting digital book data of four pages into digital book data of one page) is set as another similar optimum arithmetic processing, the magazine sort is performed as described below.

That is, first, a determination is made as to whether the page number (n) of the final page (n-th page) is a multiple of 8, and blank pages are appropriately added so that the whole page number becomes the multiple of 8, and the temporal digital book data is formed.

Thereafter, page data arranged in order of 1, 2, 3, 4, 5, 6, 7, 8 . . . , n+k−7, n+k−6, n+k−5, n+k−4, n+k−3, n+k−2, n+k−1, n+k has only to be rearranged in order of n+k−1, n+k, 1, 2, 3, 4, n+k−3, n+k−2, n+k−5, n+k−4, 5, 6, 7, 8, n+k−7, n+k−6, . . . .

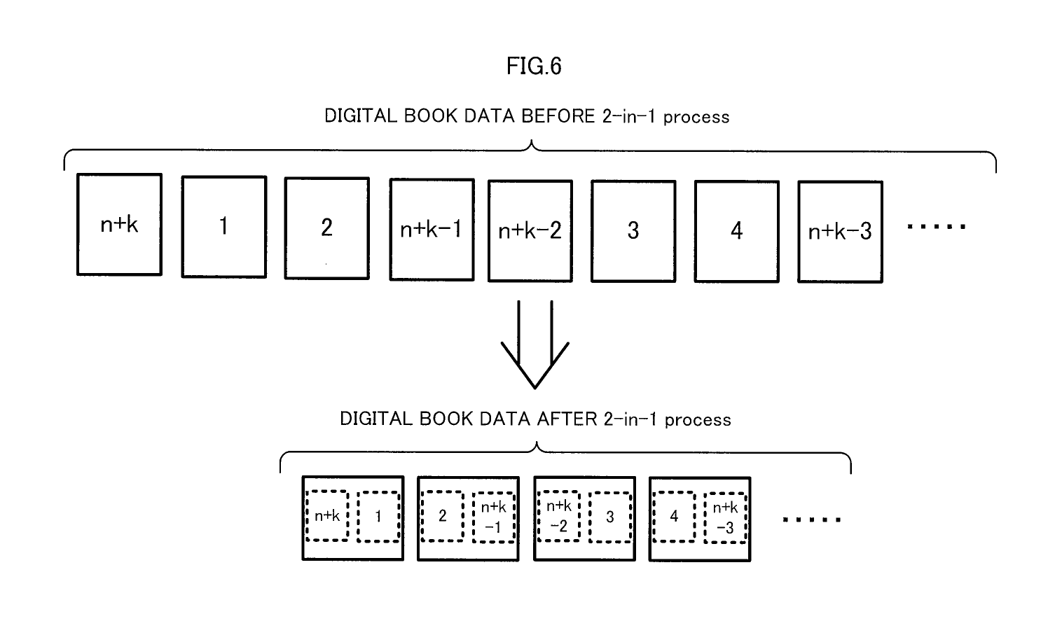

FIG. 6 is a view for explaining the 2-in-1 process. As shown in FIG. 6, when the 2-in-1 process is set as an optimum arithmetic processing, the image processing part 71 sequentially fetches the digital book data, on which the magazine sort is performed, from the page memory 75 in units of two pages from the first page, converts digital book data of two pages fetched at one time into digital book data of one page, and stores in the page memory 75. Incidentally, when the data is stored in the page memory 75, a contraction process is performed so that the digital book data of two pages has the same size as the size of each page of the digital book data before the 2-in-1 process is performed.

When the 4-in-1 process is set as the optimum arithmetic processing, data is fetched from the page memory 75 in units of four pages from the first page, and digital book data of four pages fetched at one time is converted into digital book data of one page and is stored in the page memory 75 after the contraction process is performed.

When the digital book print mode is set at Act 105, or the normal print mode is set at Act 102, the main control part 70 starts printing in accordance with the setting (Act 106).

At Act 106, when the digital book print mode is set, the main control part 70 controls the inversion conveyance part 32 so that the images based on the arithmetically processed digital book data are printed on both sides of the sheet of the specified size in the image forming part 14. The image forming part 14 prints the images based on the arithmetically processed digital book data on both sides of the sheet by the controlled inversion conveyance part 32.

Further, when the images based on the arithmetically processed digital book data are printed on both sides of the sheet, the main control part 70 controls the finisher control part 78 so that saddle stitch is performed to a bundle of sheets on both sides of each of which the images are printed based on the arithmetically processed digital book data.

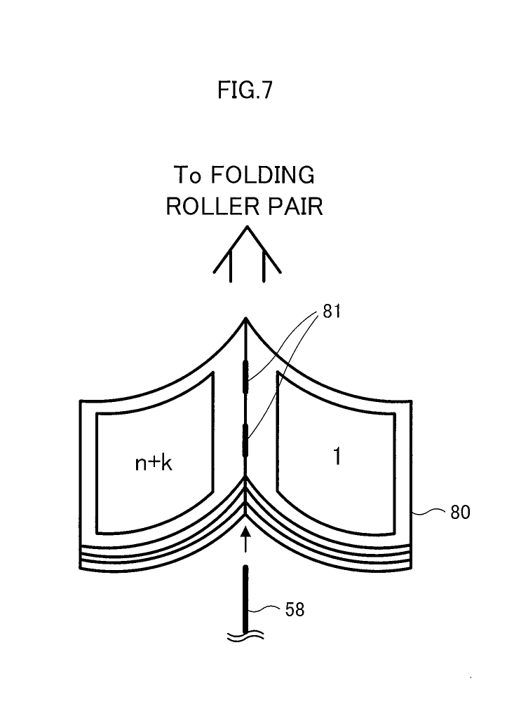

When the finisher control part 78 is controlled, as shown in FIG. 7, the saddle stitch part 40 staples the sheet bundle by driving a C-shaped sheet binding member 81 into a center part of a sheet bundle 80, and pushes the center part of the sheet bundle 80 into a space between the folding roller pair 57 by the blade 58.

When the folding roller pair 57 fold the sheet bundle, the sheet bundle folded in two is conveyed by the discharge roller pair 59 and is discharged to the paper discharge tray 44.

The saddle stitch is performed to the sheet bundle as stated above, so that a book is formed from the digital book data.

According to the image forming apparatus and the image forming method of the embodiment described above, when the determination is that the image data to be printed is the digital book data, the digital book print mode for forming the book from the digital book data is automatically displayed on the display part 79 of the control panel 76, and this mode is automatically set to the image forming apparatus 10. Accordingly, the user can easily print the digital book and forms the book.

### Second Embodiment

Since the structure of an image forming apparatus of a second embodiment is the same as the image forming apparatus 10 shown in FIG. 1, the description thereof is omitted, and an image forming method of the second embodiment will be described below.

The image forming method of the second embodiment is different from the image forming method of the first embodiment in that plural digital book print modes are stored in a RAM 74, and the user can select one print mode from the plural digital book print modes. This method will be described below.

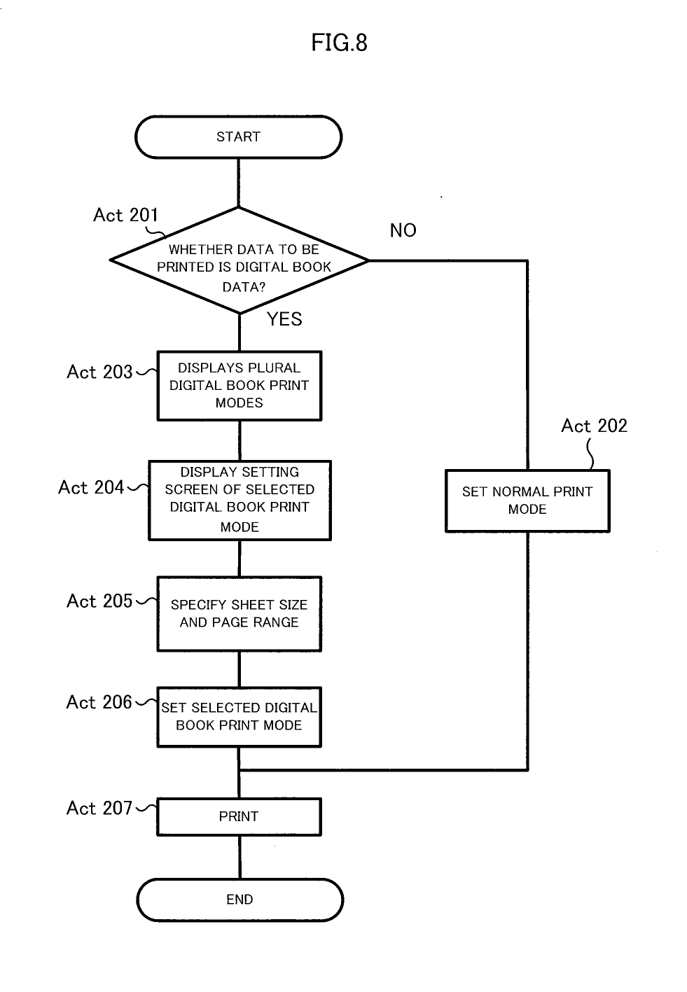

FIG. 8 is a flowchart showing the image forming method of the second embodiment.

First, similarly to the image forming method of the first embodiment, a main control part 70 determines whether image data to be printed is digital book data (Act 201). When the determination is that the image data is not the digital book data (Act 201, NO), the main control part 70 sets a normal print mode (Act 202).

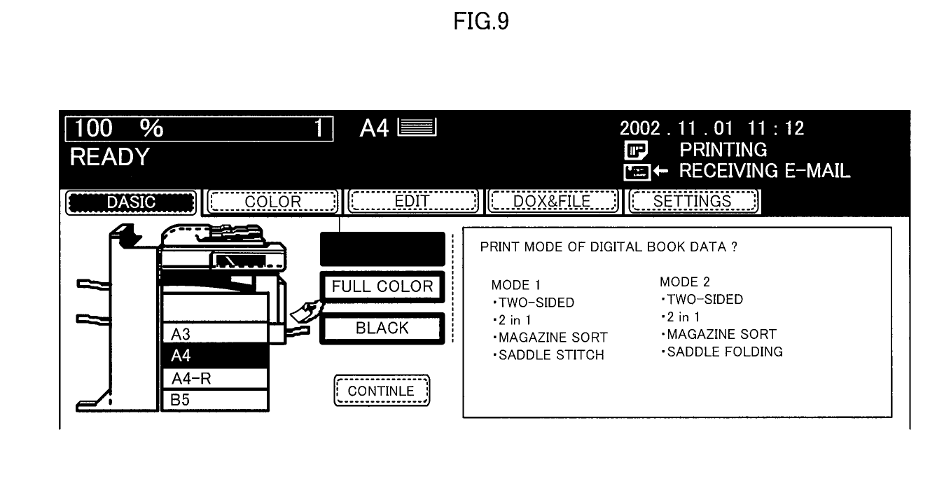

At Act 201, when the determination is that the image data is the digital book data (Act 201, YES), the main control part 70 reads information relating to the plural digital book print modes stored in the RAM 74, and automatically displays the plural digital book print modes as shown in FIG. 9 on a display part 79 of a control panel (Act 203).

In FIG. 9, as the digital book print modes, a mode 1 and a mode 2 are displayed. The mode 1 is a mode similar to the print mode described in the first embodiment. The mode 2 is a mode in which the saddle stitch of the mode 1 is replaced by saddle folding.

The user selects one print mode from the plural digital book print modes displayed as in FIG. 9. The user operates the control panel 76 so that this selection is performed.

When the user selects one print mode from the plural digital book print modes, the main control part 70 displays a setting screen of the selected digital book print mode on the display part 79 of the control panel 76 similarly to FIG. 4 (Act 204). Further, on this setting screen, when the user specifies the page range of the digital book data and specifies the size of a sheet to be printed (Act 205), the main control part 70 fetches the digital book data within the specified page range from a page memory 75, and controls a sheet conveyance part 15 so that a sheet of the specified sheet size is taken out from one of cassette mechanisms 30a to 30d. Next, the main control part 70 sets the digital book print mode displayed on the display part 79 of the control panel 76 at Act 204 to the image forming apparatus (Act 206), or when the normal print mode is set at Act 202, the main control part 70 starts printing in accordance with the setting (Act 207).

Incidentally, in the mode 2 shown in FIG. 9, the saddle folding means that in a saddle stitch part 40 of a finisher 12, a sheet bundle is folded in two without stapling the sheet bundle.

Also in the image forming apparatus and the image forming method of this embodiment described above, when the determination is that the image data to be printed is the digital book data, the digital book print mode for forming a book from the digital book data is automatically displayed on the display part 79 of the control panel 76, and this mode is automatically set to the image forming apparatus 10. Accordingly, the user can easily print the digital book and forms the book.

Further, according to the image forming apparatus and the image forming method of this embodiment, the plural digital book print modes are displayed on the display part 79 of the control panel 76, and the user can select one mode from these. Accordingly, the user can form a more desirable book.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the digital book print mode is not limited to the print mode shown in the embodiment. For example, the user operates the control panel 76 and can appropriately specify the digital book print mode. Accordingly, the digital book print mode may be, for example, only the magazine sort and two-sided printing.

The various digital book print modes specified as stated above are stored in the RAM 74 of the main control part 70. When the determination part 72 determines that the image data is the digital book data, the specified digital book print mode is read from the RAM 74 and is displayed on the display part 79, and this print mode is set to the image forming apparatus 10. In this case, the main control part 70 controls at least one of the image processing part 71, the inversion conveyance part 32 and the finisher control part 78 according to the specified digital book print mode.

What is claimed is:

1. An image forming apparatus comprising:
a determination part to determine whether image data is digital book data;
a display part that automatically displays a digital book print mode for forming a book from the digital book data if the determination part determines that the image data is the digital book data;
an image processing part to arithmetically process the digital book data;
an image forming part to form an image based on the digital book data on a sheet;
an inversion conveyance part that inverts the sheet on one side of which the image is formed by the image forming part and conveys the sheet to the image forming part;
a finishing part to finish the sheet on which the image is formed by the image forming part, and
a main control part that includes the determination part and the image processing part, and automatically controls at least one of the image processing part, the inversion conveyance part and the finishing part specified based on the digital book print mode displayed on the display part.

2. The apparatus of claim 1, further comprising an external connection part to capture the image data or the digital book data from an outside of the image forming apparatus, wherein
when the digital book data is captured through the external connection part, the determination part determines that the image data is the digital book data.

3. The apparatus of claim 2, wherein the external connection part connects the image forming apparatus and Internet to enable mutual communication.

4. The apparatus of claim 2, wherein the external connection part connects the image forming apparatus and an external storage device storing the digital book data to enable mutual communication.

5. The apparatus of claim 1, further comprising an inner storage device storing the digital book data, wherein
when the digital book data stored in the inner storage device is selected by the display part, the determination part determines that the image data is the digital book data.

6. The apparatus of claim 1, wherein
when the determination part determines that the image data is the digital book data, the display part automatically displays a plurality of the digital book print modes for forming a book from the digital book data, and
the main control part includes the determination part and the image processing part, and automatically controls at least one of the image processing part, the inversion conveyance part and the finishing part specified based on one digital book print mode selected from the plurality of digital book print modes displayed on the display part.

7. The apparatus of claim 1, wherein
the finishing part includes a saddle stitch part to perform a saddle stitch in which a center part of the sheets on which the image is formed by the image forming part are stapled and the sheets are folded in two along the center part,
the digital book print mode is a mode in which an optimum arithmetic processing to form the book is performed on the digital book data, images based on the arithmetically processed digital book data are formed on both sides of the sheet, and the saddle stitch is performed on the sheet on both the sides of which the images based on the arithmetically processed digital book data are formed, and
the main control part controls the image processing part, the inversion conveyance part and the finishing part based on the mode, and the image processing part performs the optimum arithmetic processing on the digital book data, the inversion conveyance part conveys the sheet and causes the image forming part to form the images based on the arithmetically processed digital book data on both the sides of the sheet, and the saddle stitch part saddle stitches the sheet on both the sides of which the images based on the arithmetically processed digital book data are formed.

8. The apparatus of claim 1, wherein
the finishing part includes a saddle stitch part to perform saddle folding in which the sheet on which the image is formed by the image forming part is folded in two along a center part,
the digital book print mode is a mode in which an optimum arithmetic processing to form the book is performed on the digital book data, images based on the arithmetically processed digital book data are formed on both sides of the sheet, and a saddle stitch is performed on the sheet on both the sides of which the images based on the arithmetically processed digital book data are formed, and
the main control part controls the image processing part, the inversion conveyance part and the finishing part based on the mode, and the image processing part performs the optimum arithmetic processing on the digital book data, the inversion conveyance part conveys the sheet and causes the image forming part to form the images based on the arithmetically processed digital book data on both the sides of the sheet, and the saddle stitch part saddle stitches the sheet on both the sides of which the images based on the arithmetically processed digital book data are formed.

9. An image forming method comprising:
determining whether image data is digital book data;
automatically displaying a digital book print mode for forming a book from the digital book data if the determination is that the image data is the digital book data;
automatically controlling, based on the displayed digital book print mode, at least one of an image processing part that arithmetically processes the digital book data, an inversion conveyance part that inverts a sheet on one side of which an image is formed by an image forming part to form the image based on the digital book data on the sheet, and conveys the sheet to the image forming part, and a finishing part that finishes the sheet on which the image is formed by the image forming part; and
forming a book by an image forming apparatus including the image processing part, the inversion conveyance part and the finishing part which are controlled based on the digital book print mode, and the image forming part.

10. The method of claim 9, wherein in determining whether the image data is the digital book data, when the digital book data is captured into the image forming apparatus from an outside of the image forming apparatus, the determination is that the image data is the digital book data.

11. The method of claim 10, wherein the digital book data is captured into the image forming apparatus from the outside of the image forming apparatus through Internet.

12. The method of claim 10, wherein the digital book data is captured into the image forming apparatus from an external storage device storing the digital book data.

13. The method of claim 9, wherein in determining whether the image data is the digital book data, when the digital book data stored in an inner storage device of the image forming apparatus is selected, the determination is that the image data is the digital book data.

14. The method of claim 9, wherein
a plurality of the digital book print modes are displayed, and
at least one of the image processing part, the inversion conveyance part and the finishing part is automatically controlled based on one digital book print mode selected from the plurality of the displayed digital book print modes.

15. An image forming method comprising:
determining whether image data is digital book data;
automatically displaying a digital book print mode for forming a book from the digital book data if the determination is that the image data is the digital book data;
automatically controlling, based on the displayed digital book print mode, an image processing part that performs an optimum arithmetic processing for forming the book on the digital book data, an inversion conveyance part that inverts a sheet on one side of which an image is formed by an image forming part to form the image based on the digital book data on the sheet, and conveys the sheet to the image forming part, and a finishing part that includes a saddle stitch part to staple a center part of the sheet on which the image is formed by the image forming part and to fold the sheet in two along the center part of the sheet; and
forming the book by an image forming apparatus including the image processing part, the inversion conveyance part and the finishing part which are controlled based on the digital book print mode, and the image forming part.

16. The method of claim 15, wherein in determining whether the image data is the digital book data, when the digital book data is captured into the image forming apparatus from an outside of the image forming apparatus, the determination is that the image data is the digital book data.

17. The method of claim 16, wherein the digital book data is captured into the image forming apparatus from the outside of the image forming apparatus through Internet.

18. The method of claim 16, wherein the digital book data is captured into the image forming apparatus from an external storage device storing the digital book data.

19. The method of claim 15, wherein in determining whether the image data is the digital book data, when the digital book data stored in an inner storage device of the image forming apparatus is selected, the determination is that the image data is the digital book data.

20. The method of claim 15, wherein
a plurality of the digital book print modes are displayed, and
at least one of the image processing part, the inversion conveyance part and the finishing part is automatically controlled based on one digital book print mode selected from the plurality of the displayed digital book print modes.
